(19) United States
(12) Patent Application Publication
(10) Pub. No.: US 2022/0197358 A1
(43) Pub. Date: Jun. 23, 2022

(54) SYSTEM AND METHODS FOR PROVIDING POWER TO A DATA CENTER

(71) Applicant: Baidu USA LLC, Sunnyvale, CA (US)

(72) Inventor: TIANYI GAO, Sunnyvale, CA (US)

(21) Appl. No.: 17/132,492

(22) Filed: Dec. 23, 2020

(51) Int. Cl. G06F 1/26; H05K 7/14; H05K 7/20; H02J 3/38; H02S 10/10; H02S 40/30

(52) U.S. Cl. CPC G06F 1/263; H05K 7/1492; H05K 7/20709; H02J 2300/24; H02S 10/10; H02S 40/30; H02J 3/381

(57) ABSTRACT

A method and system of managing power within a data center and providing power to the load including IT equipment includes determining a required power level for a data center, and determining a level of renewable energy available from one or more renewable energy sources. The method also includes determining a level of power available within a primary storage system for the data center. In addition, the method includes selectively utilizing renewable energy from the renewable energy sources to charge the primary storage system or power server racks, a cooling system, or a lighting system.

### FIELD OF THE DISCLOSURE

Embodiments of the present disclosure relate generally to data center power architecture. More particularly, embodiments of the disclosure relate to systems and methods for providing power to a data center from various sources.

### BACKGROUND

Data centers are mission critical facilities which are used for housing IT equipment and servers. The variation in business requirements and use cases, variation in computing power requirements, etc. cause significant variation in IT equipment design. Data centers are expanding very fast, and their total energy consumption is also growing rapidly. Every year, companies with large data centers spend large sums of money on electricity. A need, therefore, exists for systems that can reduce electricity costs and more efficiently utilize power within data centers. Renewable power has started to attract a lot of attention from hyperscale data center owners.

### BRIEF DESCRIPTION OF THE DRAWINGS

Embodiments of the invention are illustrated by way of example and not limitation in the figures of the accompanying drawings in which like references indicate similar elements.

FIG. 1 shows an example design of a power distribution system in a data center, according to an embodiment of the present disclosure.

FIG. 2 shows another example design of a power distribution system in a data center, according to an embodiment of the present disclosure.

FIG. 3 shows another example design of a power distribution system in a data center, according to an embodiment of the present disclosure.

FIG. 4 shows a partial schematic of an example power distribution system in a first mode of operation, according to an embodiment of the present disclosure.

FIG. 5 shows a partial schematic of an example power distribution system in a second mode of operation, according to an embodiment of the present disclosure.

FIG. 6 shows a partial schematic of an example power distribution system in a third mode of operation, according to an embodiment of the present disclosure.

FIG. 7 shows a partial schematic of an example power distribution system in a fourth mode of operation, according to an embodiment of the present disclosure.

FIG. 8 is a flow diagram of an example method for distributing power within a data center, according to an embodiment of the present disclosure.

FIG. 9 is a flow diagram of another example method for distributing power within a data center, according to an embodiment of the present disclosure.

FIG. 10 is a block diagram illustrating an example of a data processing system that may be used with embodiments described herein.

### DETAILED DESCRIPTION

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

In the description of the embodiments provided herein, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other. Additionally, the terms “server,” “client,” and “device” are intended to refer generally to data processing systems rather than specifically to a particular form factor for the server, client, and/or device.

Green energy systems, like wind turbines and solar panels, are increasingly lower in cost and also low in carbon emissions. However, the power produced by those intermittent resources is at times neither consistent nor predictable. Thus, the heterogeneous energy storage devices (ESDs) can be jointly used in a system to store renewable energy. In this way, intermittent resources can be efficiently used to serve the workload of a data center and reduce the total electricity costs. According to one embodiment, a particular control algorithm can be used to control the converters and switches within a power distribution system when using renewable energy sources. Due to the uncertainty of the intermittent resources, batteries can also be used to store energy where there is sufficient power produced, and to serve the workloads when needed. The use of renewable power may reduce both the capital costs and operational costs, as well as reducing the impact on the environment.

According to conventional techniques, different types of redundant power systems are utilized, including isolated and parallel redundant, RR, DR, N+N, 2(N+1) and so on. A shortfall of such an architecture is that it is costly. In addition, such architectures implement a battery within the UPS, which provides less system flexibility.

According to one embodiment, a novel architecture is disclosed for powering a data center using different power sources. In addition, the techniques disclosed herein enable a system to control and dispatch power flow from different sources in several combinational modes in different scenarios. The present disclosure not only enables a system to implement renewable energy, such as solar power, into a data center for powering an IT cluster, but also enables an efficient architecture to integrate the system together with multiple other power sources, including utility power as well as energy storage systems. Furthermore, the control design provides an operation method for more intelligent system power flow arrangement.

In an embodiment, a power system design for a data center and IT clusters is proposed. The power system includes multiple power resources for providing power to data centers at normal and abnormal modes of operation. The architectural design, together with the corresponding system operation control, provides a more efficient and reliable power system for data centers, especially modular data centers.

In one embodiment, the design includes the system level architecture and the control. In the system level, there may be at least three design configurations, which are different in a bypass loop design. The control design enables the use of multiple resources in the data center under different conditions. In an embodiment, a number of switches and converters, as well as DC buses, are implemented in the system for enabling different power sources within the system, and for power dispatching and operating optimization. A controller can be used to operate each of the switches according to the power flow control to switch between different scenarios or modes of operation.

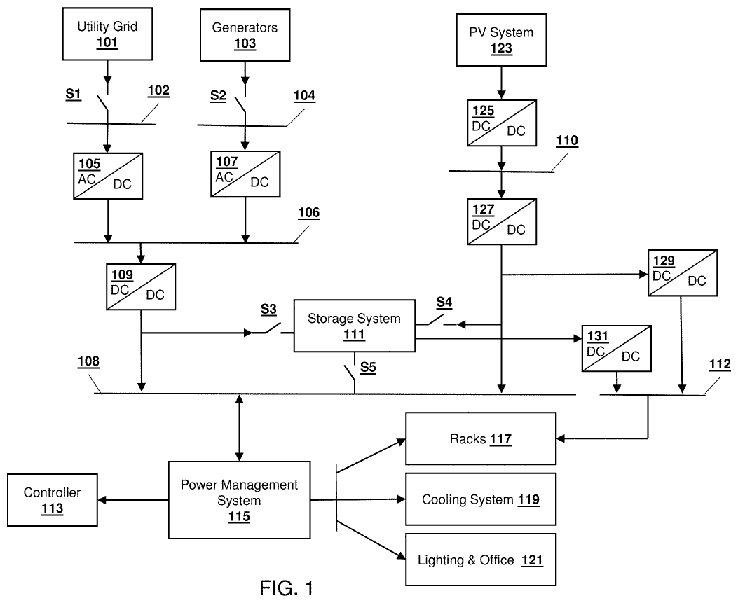

FIG. 1 shows an example design of a power distribution system in a data center, according to an embodiment of the present disclosure. In some embodiments, the system can include several potential power sources. In this embodiment, the system includes a utility grid 101, generators 103, and a renewable energy source such as a photovoltaic (PV) system 123. The utility grid 101 is connected to a first rectifier 105 via a first switch S1 and a first AC bus 102. Similarly, the generators 103 can be connected to a second rectifier 107 via a second switch S2 and a second AC bus 104. These switches and AC buses can be used, in some embodiments, so that different formats of power sources can be connected to the power distribution system.

In this embodiment, the first and second rectifiers 105, 107 can be connected to a first DC converter 109 via a first DC bus 106. This first DC converter 109 can then be connected to a second DC bus 108, and to a storage system 111 via a third switch S3. The storage system 111 can also be connected to the second DC bus 108 via a fifth switch S5. One skilled in the art would understand that the DC bus 108 may be physically implemented at the facility power level or at IT rack level, or inside of the rack.

In an embodiment, the PV system 123 can be connected to a second DC converter 125, a third DC bus 110, and a third DC converter 127. In some embodiments, the second DC converter 125 and the third DC bus 110 allows for several different formats of renewable power sources to be connected to the power distribution system. The third DC converter 127 can be selectively connected to the storage system 111 via a fourth switch S4. The third DC converter 127 can also be connected to the second DC bus 108 and a fourth DC converter 129. The storage system 111 can also be connected to a fifth DC converter 131. In an embodiment, the fourth DC converter 129 and the fifth DC converter 131 are connected to a fourth DC bus 112. One skilled in the art would understand that some of the DC converters may be eliminated in some architectures which results in a similar function. For instance, 127 can be eliminated and 131 can be integrated into the storage system 111.

In an embodiment, a number of different renewable energy sources can be connected to the third DC bus 110 so that additional renewable energy sources can be integrated within the power distribution system.

In an embodiment, the second DC bus 108 is connected to a power management system 115, which is in turn connected to a controller 113, as well as IT racks 117, a cooling system 119, and a lighting & office power system 121. The fourth DC bus 112 can also be connected to the racks 117 to provide power independently of the power management system 115, in this embodiment. The controller 113 can be connected to each of the five switches S1, S2, S3, S4, and S5 (connections not shown for simplicity), in order to control the operation of the switches and change the modes of operation of the power management system. In some embodiments, the power management system 115 and controller 113 can control and dispatch the power flow in the grid according to the current workload, power resource availability of the storage system 111 and the renewable energy source, and the cost of non-renewable energy at any given moment.

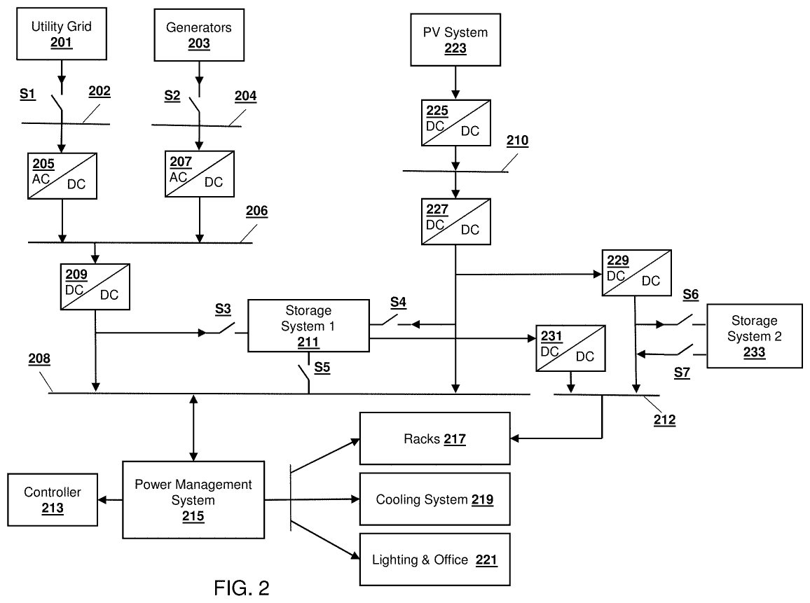

FIG. 2 shows another example design of a power distribution system in a data center, according to an embodiment of the present disclosure. This example system includes a second storage system 233 added before the fourth DC bus 212 via sixth and seventh switches S6 and S7. This second storage system 233 can be used to deliver power to the racks and maybe dedicated for certain critical IT equipment populated in the rack. Both storage system 1 and storage system 2 can be used for powering the rack, however, the design with additional storage system 2 may improve the energy usage efficiency and may provide extra power management advantages based on the IT rack requirements and workload design running on the racks.

In this embodiment, the system includes a utility grid 201, generators 203, and a renewable energy source such as a photovoltaic (PV) system 223. The utility grid 201 is connected to a first rectifier 205 via a first switch Si and a first AC bus 202. Similarly, the generators 203 can be connected to a second rectifier 207 via a second switch S2 and a second AC bus 204. These switches and AC buses can be used, in some embodiments, so that different formats of power sources can be connected to the power distribution system. In one conventional system, ATS (automatic transfer switch) may be used between 201 and 203, or among multiple different power buses.

In an embodiment, the first and second rectifiers 205, 207 can be connected to a first DC converter 209 via a first DC bus 206. This first DC converter 209 can then be connected to a second DC bus 208, and to a first storage system 211 via a third switch S3. The first storage system 211 can also be connected to the second DC bus 208 via a fifth switch S5.

In an embodiment, the PV system 223 can be connected to a second DC converter 225, a third DC bus 210, and a third DC converter 227. In some embodiments, the second DC converter 225 and the third DC bus 210 allows for several different formats of renewable power sources to be connected to the power distribution system. The third DC converter 227 can be selectively connected to the first storage system 211 via a fourth switch S4. The third DC converter 227 can also be connected to the second DC bus 208 and a fourth DC converter 229. The storage system 211 can also be connected to a fifth DC converter 231. In an embodiment, the fourth DC converter 229 and the fifth DC converter 231 are connected to a fourth DC bus 212. It needs to be mentioned that even though there are multiple power line connected to the storage system 1 as shown in the figure however, the storage system may only have one main input and main output, and the main input and main output are connected to different input sources or possible loads. The main input may include controlled hardware switch for switching from different charging sources, similar as the main output.

In an embodiment, the second DC bus 208 is connected to a power management system 215, which is in turn connected to a controller 213, as well as IT racks 217, a cooling system 219, and a lighting & office power system 221. The fourth DC bus 212 can also be connected to the racks 217 to provide power independently of the power management system 215, in this embodiment. The controller 213 can be connected to each of the seven switches S1, S2, S3, S4, S5, S6, and S7 (connections not shown for simplicity), in order to control the operation of the switches and change the modes of operation of the power management system.

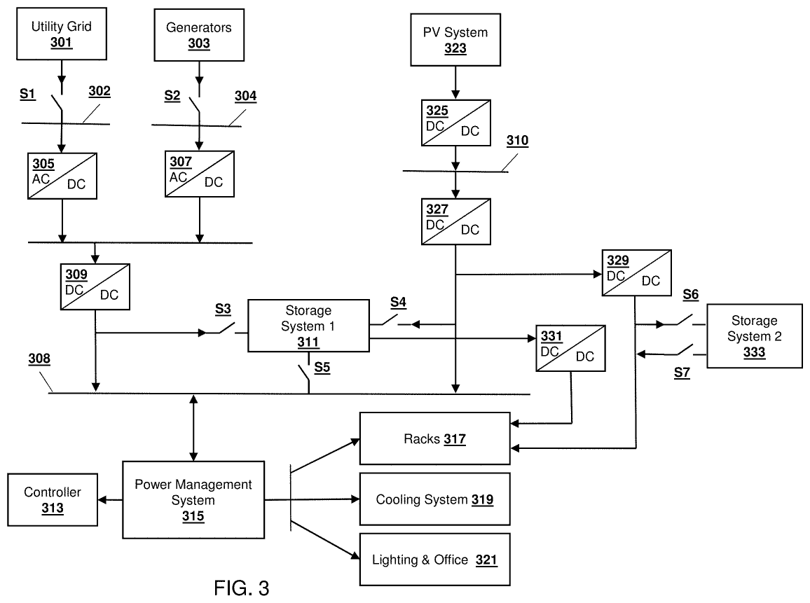

FIG. 3 shows another example design of a power distribution system in a data center, according to an embodiment of the present disclosure. In this embodiment, a second storage system 333 is able to store PV power and provide power to the racks 317 via sixth and seventh switches S6 and S7. By removing the fourth DC bus from the embodiments of FIGS. 1-2, the first storage system 311 and the second storage system 333 are disconnected to reduce the risk of a bypass loop power outage caused by a fault on the DC bus. In this design the storage system 2 can be understood as a dedicated storage unit for certain IT equipment within the rack 317. It can be understood as to satisfy different SLA based services at different hardware systems.

In this embodiment, the system includes a utility grid 301, generators 303, and a renewable energy source such as a photovoltaic (PV) system 323. The utility grid 301 is connected to a first rectifier 305 via a first switch S1 and a first AC bus 302. Similarly, the generators 303 can be connected to a second rectifier 307 via a second switch S2 and a second AC bus 304. These switches and AC buses can be used, in some embodiments, so that different formats of power sources can be connected to the power distribution system.

In an embodiment, the first and second rectifiers 305, 307 can be connected to a first DC converter 309 via a first DC bus 306. This first DC converter 309 can then be connected to a second DC bus 308, and to a first storage system 311 via a third switch S3. The first storage system 311 can also be connected to the second DC bus 308 via a fifth switch S5.

In an embodiment, the PV system 323 can be connected to a second DC converter 325, a third DC bus 310, and a third DC converter 327. In some embodiments, the second DC converter 325 and the third DC bus 310 allows for several different formats of renewable power sources to be connected to the power distribution system. The third DC converter 327 can be selectively connected to the first storage system 311 via a fourth switch S4. The third DC converter 327 can also be connected to the second DC bus 308 and a fourth DC converter 329. The storage system 311 can also be connected to a fifth DC converter 331. In an embodiment, the fourth DC converter 329 and the fifth DC converter 331 are connected to the racks 317.

In an embodiment, the second DC bus 308 is connected to a power management system 315, which is in turn connected to a controller 313, as well as IT racks 317, a cooling system 319, and a lighting & office power system 321. The controller 313 can be connected to each of the seven switches S1, S2, S3, S4, S5, S6, and S7 (connections not shown for simplicity), in order to control the operation of the switches and change the modes of operation of the power management system.

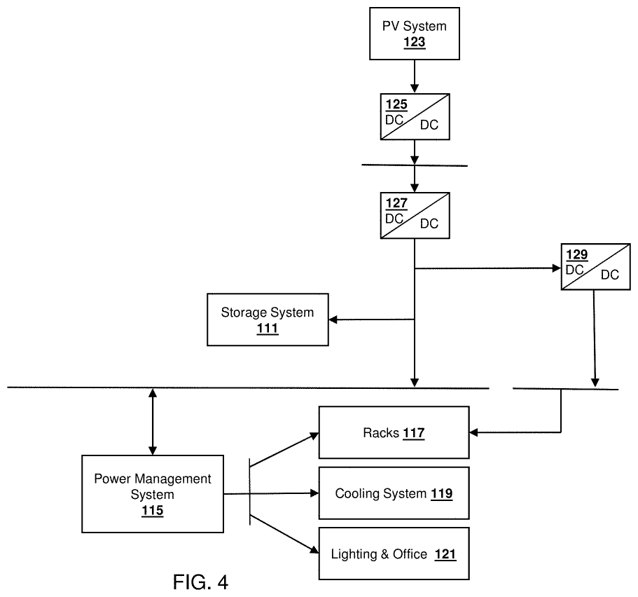

FIG. 4 shows a partial schematic of the example power distribution system of FIG. 1 in a first mode of operation, according to an embodiment of the present disclosure. In this embodiment, described as case 1 in Table 1, below, there is enough power from the PV system 123 and this PV power is used to serve the workload as well as charge the storage system 111 (if needed). The fourth switch S4 is closed in this embodiment to charge the storage system 111.

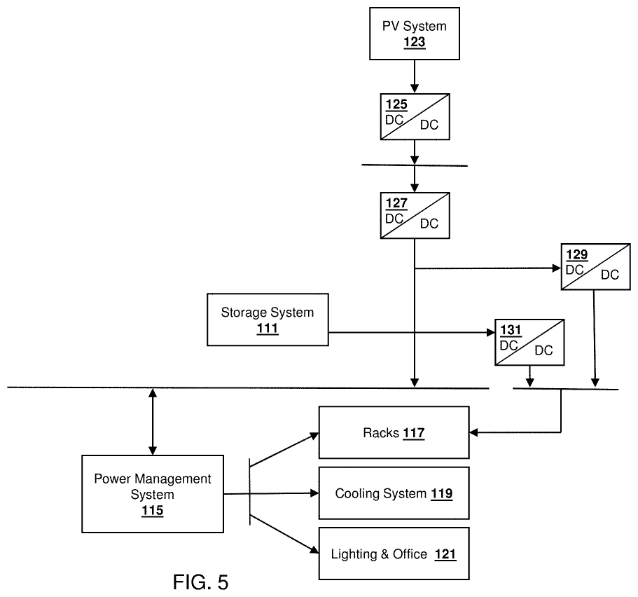

FIG. 5 shows a partial schematic of an example power distribution system of FIG. 1 in a second mode of operation, according to an embodiment of the present disclosure. In this embodiment, described as case 2 in Table 1, below, there is renewable energy present but the power produced by the PV system 123 is not sufficient, so both renewable power and the storage system 111 are used to serve the workload. This scenario may happen when utility power is not needed, or when utility power is unavailable, in some embodiments. Each of the switches is off or open in this example embodiment.

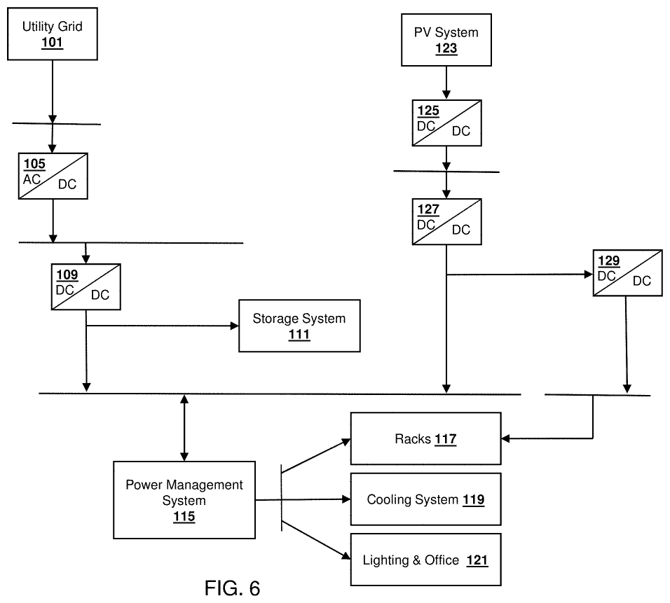

FIG. 6 shows a partial schematic of an example power distribution system of FIG. 1 in a third mode of operation, according to an embodiment of the present disclosure. In this embodiment, described as case 3 in Table 1, there is renewable energy present, but the power produced by the PV system 123 and the storage system 111 has low energy, so utility power is used from the utility grid 101 to serve the workload as well as to charge the storage system 111. The first and third switches S1 and S3 are closed, in this example embodiment, to charge the storage system 111 from the utility grid 101.

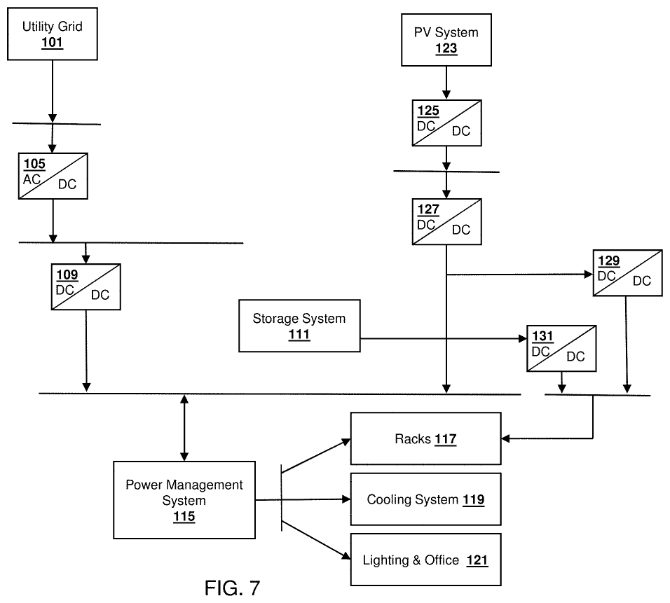

FIG. 7 shows a partial schematic of an example power distribution system of FIG. 1 in a fourth mode of operation, according to an embodiment of the present disclosure. In this embodiment, described as case 4 in Table 1, there is renewable energy, and the storage system 111 may provide power as well, but neither the PV system 123 nor the storage system 111 have enough power. In this embodiment, the first switch S1 is closed to use utility power to serve the workload, along with the PV system 123 and storage system 111.

TABLE 1

| Operation | | | | | |
|---|---|---|---|---|---|
| Scenarios | S1 | S2 | S3 | S4 | S5 |
| Case 1 | OFF | OFF | OFF | ON | OFF |
| Case 2 | OFF | OFF | OFF | OFF | OFF |
| Case 3 | ON | OFF | ON | OFF | OFF |
| Case 4 | ON | OFF | OFF | OFF | OFF |
| Case 5 | ON | OFF | ON | OFF | OFF |
| Case 6 | ON | OFF | OFF | OFF | OFF |
| Case 7 | OFF | OFF | OFF | OFF | OFF |

As can be seen in Table 1, a number of different cases are shown with different switch statuses. Cases 5-7 are other possible operation scenarios that can be used in the architecture described in FIG. 1, when renewable sources are not in use. For example, case 5 represents a situation and operation where there is no renewable energy and the storage system power is insufficient, so utility power is used as the main source to serve the workload and also to charge the storage system. Case 6 represents a scenario using the storage system for peak power during a short period of time, while utility power is the main power source. In this sixth case, the renewable line is disconnected from the DC bus. Case 7 represents a scenario that uses the storage system only to power the IT racks. The scenarios provided by a second storage system as shown in FIG. 2 and FIG. 3 may add additional operation sub-scenarios depending on the design. For instance, a dedicated storage system connected to the PV system is only for certain IT equipment which runs critical workload, or may need larger backup power or peak power, and so on.

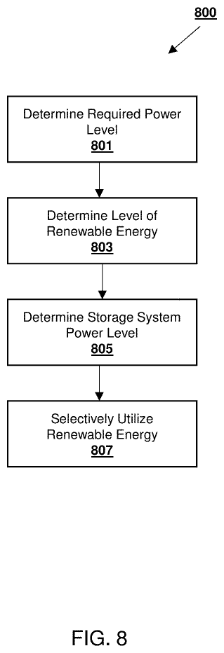

FIG. 8 is a flow diagram of an example method 800 for distributing power within a data center, according to an embodiment of the present disclosure. The power distribution method 800 can be implemented, for example, using the power distribution system described in FIGS. 1-7. At operation 801, the method 800 determines a required power level for a data center.

At operation 803, the method 800 determines a level of renewable energy available from one or more renewable energy sources. In an embodiment, the renewable energy sources can include a PV system, a wind generated power system, or some other type of renewable energy source. In some embodiments, a number of renewable energy sources can be connected via a renewable energy source bus (e.g. the third DC bus 110 of FIG. 1).

At operation 805, the method 800 determines a level of power available within a primary storage system for the data center. In another embodiment, additional storage system power, such as storage system 2, is also measured and determined at this operation.

At operation 807, the method 800 selectively utilizes the renewable energy within the data center. In an embodiment, the renewable energy is used to charge the primary storage system or power server racks, a cooling system, or a lighting system within the data center.

In an embodiment, the level of renewable energy is above a required power level for the data center, so the renewable energy is used to charge the primary storage system and to power the IT racks, cooling system, and/or lighting system.

In another embodiment, the renewable energy is below the required power level for the data center, and a primary utility power source is not present, so a combination of the renewable energy and energy from the storage system is used to power the IT racks, cooling system, and/or lighting system.

In another embodiment, the renewable energy is below the required power level of the data center, and the primary power source is present, so a combination of renewable energy and the primary utility power is used to charge the primary storage system and to power the IT racks, cooling system, and/or the lighting system.

In another embodiment, a combination of the renewable energy and the storage system power is below the required power level for the data center; so a combination of the renewable energy, the storage system, and the primary power source is used to power the IT racks, cooling system, and/or the lighting system.

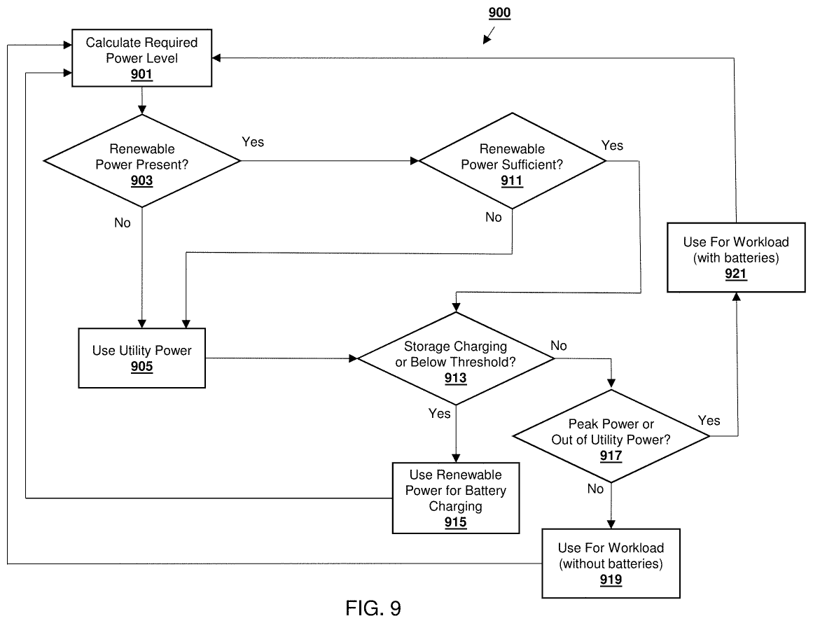

FIG. 9 is a flow diagram of another example method 900 for distributing power within a data center, according to an embodiment of the present disclosure. The power distribution method 900 can be implemented, for example, using the power distribution system described in FIGS. 1-7. At operation 901, the method 900 calculates the required power level for the data center.

At operation 903, it is determined whether renewable power is present. If no renewable power is present, the method continues at operation 905 to use utility power. If renewable power is present, it is determined at operation 911 whether the renewable power is sufficient to be utilized. If not, the method again continues at operation 905 to use utility power.

If there is sufficient utility power, the method continues at operation 913 with determining whether a storage system, such as a battery system, is charging or below a particular threshold. If the storage system is charging or below a particular threshold level, the method continues at operation 915 with using renewable power for battery charging.

If it is determined at operation 915 that the storage system is not charging or is not below a particular threshold value, the method continues at operation 917 with determining whether the system is operating at peak power or if the utility power is absent. If the system is not operating at peak power, or if the utility power is present, the method can continue at operation 919 with using renewable power for the data center workload. In an embodiment, at operation 919 the renewable energy is used for the data center workload without the additional use of the storage system or battery power.

If it is determined at operation 917 that the system is operating at peak power, or that the utility power is absent, the method can continue at operation 921 with using both the renewable power and the battery power for the data center workload. In an embodiment, after each of operations 915, 919, and 921, the method returns to operation 901.

According to the method 900 described in FIG. 9, the renewable energy is used to its maximum amount when available. In addition, the design utilizes different power sources effectively in a combination of modes to accommodate different scenarios and power requirements. The system can be implemented using any one of the architectures described in FIG. 1-7 or 10. The system can be arranged in a modular design, and can allow for the implementation of different types of renewable energy sources with the power distribution system.

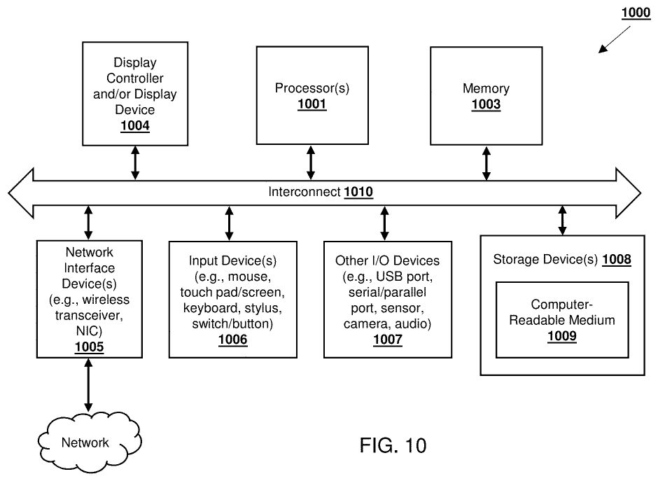

FIG. 10 is a block diagram illustrating an example of a data processing system 1000 that may be used with embodiments described herein. The data processing system 1000 may represent any of the data processing systems described above and may perform any of the processes or methods described above. The data processing system 1000 can include many different components. These components can be implemented as integrated circuits (ICs), discrete electronic devices, or other modules adapted to a circuit board such as a motherboard or add-in card of the computer system, or as components otherwise incorporated within a chassis of the computer system. Note also that the data processing system 1000 is intended to show a high-level view of many components of the computer system. However, it is to be understood that additional components may be present in certain implementations and furthermore, different arrangement of the components shown may occur in other implementations. The data processing system 1000 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment the data processing system 1000 includes one or more processor(s) 1001, memory 1003, network interface devices 1005, I/O devices 1006, 1007 and storage device(s) 1008 connected via a communication bus or an interconnect 1010. The one or more processor(s) 1001 may be a single processor or multiple processors with a single processor core or multiple processor cores included therein. The processor(s) 1001 may represent one or more general-purpose processors such as a microprocessor, a central processing unit (CPU), or the like. More particularly, the processor(s) 1001 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processor(s) 1001 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions, or chiplet based multi-chip system packages.

The processor(s) 1001 may be a low power multi-core processor, such as an ultra-low voltage processor, and may act as a main processing unit and central hub for communication with the various components of the system. Such processor can be implemented as a system on chip (SoC). The processor(s) 1001 are configured to execute instructions for performing the operations and steps discussed herein. The data processing system 1000 may further include a graphics/display subsystem 1004, which may include a display controller, a graphics processor, and/or a display device. In one embodiment at least a portion of the graphics/display subsystem 1004 is integrated into the processors(s) 1001. The graphics/display subsystem 1004 is optional and some embodiments may not include one or more components of the graphics/display subsystem 1004.

The processor(s) 1001 communicates with memory 1003, which in one embodiment can be implemented via multiple memory devices to provide for a given amount of system memory. The memory 1003 may include one or more volatile storage (or memory) devices such as random access memory (RAM), dynamic RAM (DRAM), synchronous DRAM (SDRAM), static RAM (SRAM), or other types of storage devices. The memory 1003 may store information including sequences of instructions that are executed by the one or more processor(s) 1001 or any other device. For example, executable code and/or data of a variety of operating systems, device drivers, firmware (e.g., input output basic system or BIOS), and/or applications can be loaded in the memory 1003 and executed by one of the processor(s) 1001.

The data processing system 1000 may further include I/O devices such as a network interface device(s) 1005, input device(s) 1006, and other I/O device(s) 1007. Some of the input device(s) 1006 and other I/O device(s) 1007 may be optional and are excluded in some embodiments. The network interface device(s) 1005 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

The input device(s) 1006 may include a mouse, a touch pad, a touch sensitive screen (which may be integrated with a display device of the graphics/display subsystem 1004), a pointer device such as a stylus, and/or a keyboard (e.g., physical keyboard or a virtual keyboard displayed as part of a touch sensitive screen). For example, the input device(s) 1006 may include a touch screen controller coupled to a touch screen. The touch screen and touch screen controller can, for example, detect contact and movement or a break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

The other I/O device(s) 1007 may also include an audio device. An audio device may include a speaker and/or a microphone to facilitate voice-enabled functions, such as voice recognition, voice replication, digital recording, and/or telephony functions. The other I/O device(s) 1007 may also include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. The other I/O device(s) 1007 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 1010 via a sensor hub (not shown), while other devices such as a keyboard or thermal sensor may be controlled by an embedded controller (not shown), dependent upon the specific configuration or design of data processing system 1000.

To provide for persistent storage of information such as data, applications, one or more operating systems and so forth, a mass storage (not shown) may also couple to the processor(s) 1001. In various embodiments, to enable a thinner and lighter system design as well as to improve system responsiveness, this mass storage may be implemented via a solid state device (SSD). However, in other embodiments the mass storage may primarily be implemented using a hard disk drive (HDD) with a smaller amount of flash based storage to act as an SSD cache to enable non-volatile storage of context state and other such information during power down events so that a fast power up can occur on re-initiation of system activities. In addition, a flash device may be coupled to the processor(s) 1001, e.g., via a serial peripheral interface (SPI). This flash device may provide for non-volatile storage of system software, including a basic input/output software (BIOS) as well as other firmware of the system.

The storage device(s) 1008 may include computer-readable storage medium 1009 (also known as a machine-readable storage medium) on which is stored one or more sets of instructions or software embodying any one or more of the methodologies or functions described herein. The computer-readable storage medium 1009 may also be used to store the same software functionalities described above persistently. While the computer-readable storage medium 1009 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media, or any other non-transitory machine-readable medium.

Note that while the data processing system 1000 is illustrated with various components of a data processing system, it is not intended to represent any particular architecture or manner of interconnecting the components; as such, details are not germane to embodiments of the present invention. It will also be appreciated that network computers, handheld computers, mobile phones, servers, and/or other data processing systems, which have fewer components or perhaps more components, may also be used with embodiments of the invention.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the invention also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially. Embodiments described herein are not described with reference to any particular programming language. It will be appreciated that a variety of programming languages may be used to implement the teachings of embodiments of the invention as described herein.

One skilled in the art would recognize that various adjustments can be made to the system within the scope of this disclosure.

The following clauses and/or examples pertain to specific embodiments or examples thereof. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system according to embodiments and examples described herein. Various components can be a means for performing the operations or functions described.

One embodiment provides for a method of managing power within a data center. The method includes determining a required power level for a data center, determining a level of renewable energy available from one or more renewable energy sources, and determining a level of power available within a primary storage system for the data center. The method also includes selectively utilizing renewable energy from the renewable energy sources to charge the primary storage system or power server racks and IT equipment, a cooling system, or a lighting system. In some embodiments, the level of renewable energy is above the required power level for the data center, and the method includes utilizing renewable energy to charge the primary storage system and to power server racks, a cooling system, or a lighting system. In some embodiments, the level of renewable energy is below the required power level for the data center and a primary power source is not present, and the method includes utilizing a combination of renewable energy and the primary storage system to power the server racks, the cooling system, or the lighting system. In some embodiments, the level of renewable energy is below the required power level for the data center and the primary power source is present, and the method includes utilizing a combination of renewable energy to charge the primary storage system and to power the server racks, the cooling system, or the lighting system. In some embodiments, a combination of the level of renewable energy and the primary storage system is below the required power level for the data center, and the method includes utilizing a combination of renewable energy, the primary storage system, and the primary power source to power the server racks, the cooling system, or the lighting system. In some embodiments, the renewable energy sources include a photovoltaic power source. In some embodiments, the renewable energy sources include photovoltaic power sources connected via a renewable energy source bus.

Another embodiment of the present disclosure provides for a data center system. The data center system includes one or more renewable energy sources, a primary storage system for the data center, a number of server racks, a cooling system, a lighting system, and a power controller. The power controller is configured to determine a required power level for the data center. The power controller is also configured to determine a level of renewable energy available from the renewable energy sources. The power controller also determines a level of power available within the primary storage system. The power controller also selectively utilizes renewable energy from the renewable energy sources to charge the primary storage system or to power the server racks, cooling system, or lighting system. In some embodiments, the level of renewable energy is above the required power level for the data center, and the power controller utilizes renewable energy to charge the primary storage system and to power the server racks, cooling system, or lighting system. In some embodiments, the level of renewable energy is below the required power level for the data center and a primary power source is not present, and the power controller utilizes a combination of renewable energy and the primary storage system to power the server racks, the cooling system, or the lighting system. In some embodiments, the level of renewable energy is below the required power level for the data center and the primary power source is present, and the power controller utilizes a combination of renewable energy and the primary power source to charge the primary storage system and to power the server racks, the cooling system, or the lighting system. In some embodiments, a combination of the level of renewable energy and the primary storage system is below the required power level for the data center, and the power controller utilizes a combination of renewable energy, the primary storage system, and the primary power source to power the server racks, the cooling system, or the lighting system. In some embodiments, the renewable energy sources include a photovoltaic power source. In some embodiments, the renewable energy sources include photovoltaic power sources connected via a renewable energy source bus.

Another embodiment of the present disclosure provides for a system for managing power within a data center. The system includes a number of switches within a power distribution grid, and a power controller. The power controller determines a required power level for the data center, determines a level of renewable energy available from one or more renewable energy sources, and determines a level of power available within a primary storage system of the data center. The power controller also operates the switches to selectively utilize power from a primary power source, the renewable energy sources, and the primary storage system within the power distribution grid to charge the primary storage system or to power server racks, a cooling system, or a lighting system of the data center. In some embodiments, the level of renewable energy is above the required power level for the data center, and the power controller operates the switches to utilize renewable energy to charge the primary storage system and to serve a workload of the data center. In some embodiments, the level of renewable energy is below the required power level for the data center and the primary power source is not present, and the power controller operates the switches to utilize a combination of renewable energy and the primary storage system to serve a workload of the data center. In some embodiments, the level of renewable energy is below the required power level for the data center and the primary power source is present, and the power controller operates the switches to utilize a combination of renewable energy and the primary power source to charge the primary storage system and to serve a workload of the data center. In some embodiments, a combination of the level of renewable energy and the primary storage system is below the required power level for the data center, and the power controller operates the switches to utilize a combination of renewable energy, the primary storage system, and the primary power source to serve a workload of the data center. In some embodiments, the renewable energy sources include a photovoltaic power source.

In the foregoing specification, the invention has been described with reference to specific embodiments thereof. However, various modifications and changes can be made thereto without departing from the broader spirit and scope of the invention. The specification and drawings are, accordingly, to be regarded in an illustrative rather than a restrictive sense.

What is claimed is:

1. A method of managing power within a data center, the method comprising:
determining a required power level for a data center;
determining a level of renewable energy available from one or more renewable energy sources;
determining a level of power available within a primary storage system for the data center; and
selectively utilizing renewable energy from the one or more renewable energy sources to charge the primary storage system or power at least one of: server racks and IT equipment, a cooling system, or a lighting system.

2. The method of claim 1, wherein the level of renewable energy is above the required power level for the data center, and the method further comprises:
utilizing renewable energy to charge the primary storage system and to power at least one of server racks, a cooling system, or a lighting system.

3. The method of claim 1, wherein the level of renewable energy is below the required power level for the data center and a primary power source is not present, and the method further comprises:
utilizing a combination of renewable energy and the primary storage system to power at least one of the server racks, the cooling system, or the lighting system.

4. The method of claim 1, wherein the level of renewable energy is below the required power level for the data center and the primary power source is present, and the method further comprises:
utilizing a combination of renewable energy to charge the primary storage system and to power at least one of the server racks, the cooling system, or the lighting system.

5. The method of claim 1, wherein a combination of the level of renewable energy and the primary storage system is below the required power level for the data center, and the method further comprises:
utilizing a combination of renewable energy, the primary storage system, and the primary power source to power the server racks, the cooling system, or the lighting system.

6. The method as in claim 1, wherein the one or more renewable energy sources includes a photovoltaic power source.

7. The method as in claim 1, wherein the one or more renewable energy sources includes a plurality of photovoltaic power sources connected via a renewable energy source bus.

8. A data center system, comprising:
one or more renewable energy sources;
a primary storage system for the data center;
a plurality of server racks;
a cooling system;
a lighting system; and
a power controller configured to:
determine a required power level for the data center;
determine a level of renewable energy available from the one or more renewable energy sources;
determine a level of power available within the primary storage system; and
selectively utilize renewable energy from the one or more renewable energy sources to charge the primary storage system or power at least one of the server racks, the cooling system, or the lighting system.

9. The system as in claim 8, wherein the level of renewable energy is above the required power level for the data center, and the power controller is further configured to:
utilize renewable energy to charge the primary storage system and to power at least one of server racks, a cooling system, or a lighting system.

10. The system as in claim 8, wherein the level of renewable energy is below the required power level for the data center and a primary power source is not present, and the power controller is further configured to:
utilize a combination of renewable energy and the primary storage system to power at least one of the server racks, the cooling system, or the lighting system.

11. The system as in claim 8, wherein the level of renewable energy is below the required power level for the data center and the primary power source is present, and the power controller is further configured to:
utilize a combination of renewable energy and the primary power source to charge the primary storage system and to power at least one of the server racks, the cooling system, or the lighting system.

12. The system as in claim 8, wherein a combination of the level of renewable energy and the primary storage system is below the required power level for the data center, and the power controller is further configured to:
utilize a combination of renewable energy, the primary storage system, and the primary power source to power the server racks, the cooling system, or the lighting system.

13. The system as in claim 8, wherein the one or more renewable energy sources includes a photovoltaic power source.

14. The system as in claim 8, wherein the one or more renewable energy sources includes a plurality of photovoltaic power sources connected via a renewable energy source bus.

15. A system for managing power within a data center, the system comprising:
a plurality of switches within a power distribution grid; and
a power controller configured to:
determine a required power level for the data center;
determine a level of renewable energy available from one or more renewable energy sources;
determine a level of power available within a primary storage system of the data center; and
operate the plurality of switches to selectively utilize power from a primary power source, the one or more renewable energy sources, and the primary storage system within the power distribution grid to charge the primary storage system or to power at least one of server racks, a cooling system, or a lighting system of the data center.

16. The system of claim 15, wherein the level of renewable energy is above the required power level for the data center, and the power controller is further configured to:
operate the plurality of switches to utilize renewable energy to charge the primary storage system and to serve a workload of the data center.

17. The system of claim 15, wherein the level of renewable energy is below the required power level for the data center and the primary power source is not present, and the power controller is further configured to:
operate the plurality of switches to utilize a combination of renewable energy and the primary storage system to serve a workload of the data center.

18. The system of claim 15, wherein the level of renewable energy is below the required power level for the data center and the primary power source is present, and the power controller is further configured to:
operate the plurality of switches to utilize a combination of renewable energy and the primary power source to charge the primary storage system and to serve a workload of the data center.

19. The system of claim 15, wherein a combination of the level of renewable energy and the primary storage system is below the required power level for the data center, and the power controller is further configured to:
operate the plurality of switches to utilize a combination of renewable energy, the primary storage system, and the primary power source to serve a workload of the data center.

20. The system as in claim 15, wherein the one or more renewable energy sources includes a photovoltaic power source.
